(19) United States
(12) Patent Application Publication
(10) Pub. No.: US 2010/0157141 A1
(43) Pub. Date: Jun. 24, 2010

(54) PORTABLE ELECTRONIC DEVICE WITH LENS MODULE

(75) Inventor: ZHI-BIN OUYANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/605,700

(22) Filed: Oct. 26, 2009

(30) Foreign Application Priority Data
Dec. 22, 2008 (CN) 200810306428.3

(51) Int. Cl. H04N 5/222; H04N 5/225

(52) U.S. Cl. 348/371; 348/374; 348/E05.024; 348/E05.022

(57) ABSTRACT

A portable electronic device includes a housing, a lens module, and a flash lamp module. The lens module is secured in the housing and configured for receiving incident light from the outside of the housing. The flash lamp module is secured in the housing adjacent to the lens module. The flash lamp module includes a flash lamp member and a recess. The flash lamp member emits light to the outside of the housing. The recess receives the flash lamp member and blocks flash light from refracting inside the housing into the lens module.

### BACKGROUND

1. Technical Field

The present disclosure relates to portable electronic devices, and particularly to a portable electronic device with an imaging function.

2. Description of Related Art

Lens modules are generally needed for portable electronic devices, such as digital cameras, mobile phones, or personal digital assistants, having an imaging function (e.g., still and/or video photography). A typical lens module includes a camera lens and a holder. The lens module may further include a flash lamp lens. However, the flash lamp lens is assembled with the portable electronic device and usually positioned away from the camera lens. The arrangement of the lens module and the camera lens limits the extent to which the portable electronic device can be miniaturized and thus also restricting portability.

Furthermore, portable electronic devices often have flash lamps positioned below the flash lamp lens aperture. The lens module and the flash lamps are received inside the portable electronic device. The light emitted from the flash lamp may refract into the lens module, accordingly degrading the imaging quality.

Therefore, there is room for improvement within the art.

### BRIEF DESCRIPTION OF THE DRAWING

Many aspects of the new portable electronic device can be better understood with reference to the following drawings. The components in the drawings are not necessarily drawn to scale, the emphasis instead being placed upon clearly illustrating the principles of the new portable electronic device. Moreover, in the drawings, like reference numerals designate corresponding parts throughout the several views.

FIG. 1 is an assembled isometric view of an electronic device according to an exemplary embodiment.

FIG. 2 is an exploded view of the electronic device as shown in FIG. 1.

FIG. 3 is similar to FIG. 2, showing another aspect.

FIG. 4 is a cross section of the electronic device shown in FIG. 1 and taken along IV-IV.

### DETAILED DESCRIPTION

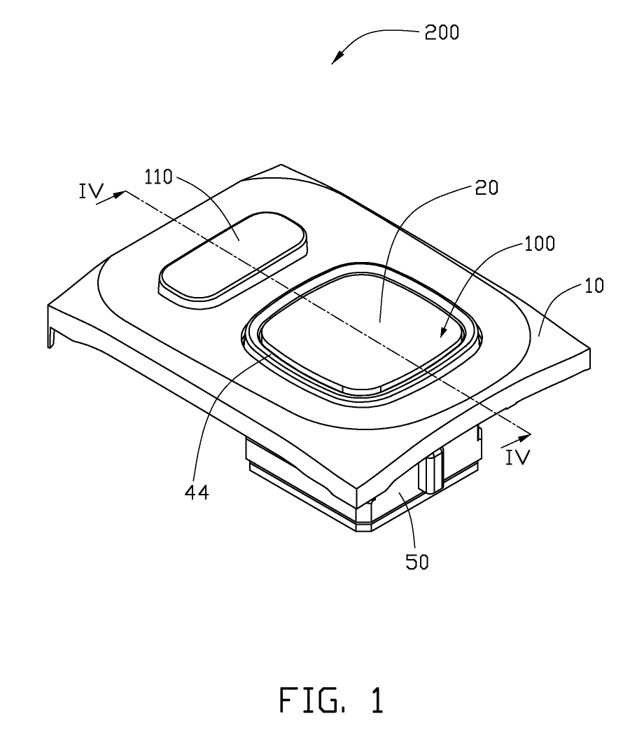

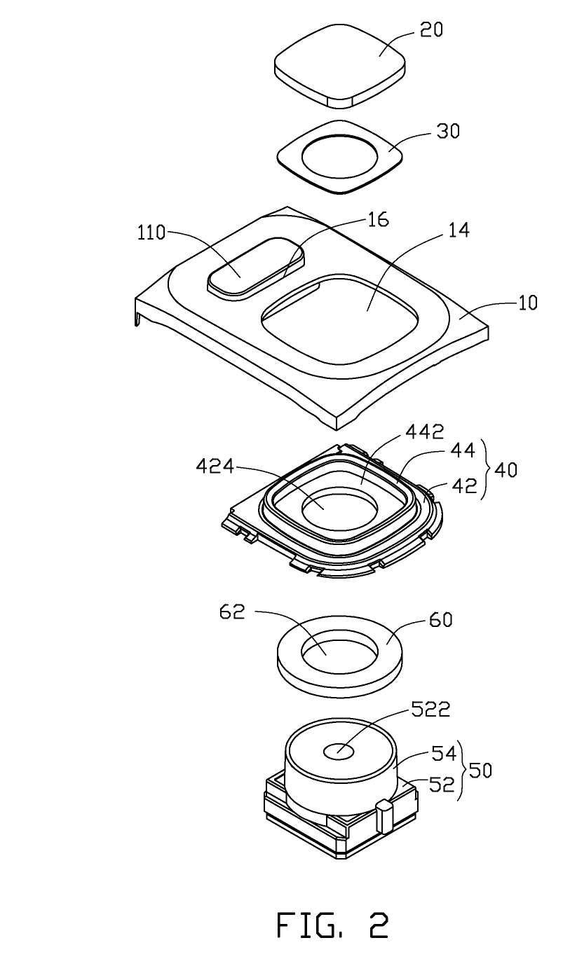

FIGS. 1 and 2 show a portable electronic device 200 (partially shown) includes a housing 10, a lens module 100 and a flash lamp module 110. The lens module 100 and the flash lamp module 110 are assembled to and exposed at an outside surface of the housing 10. The lens module 100 is positioned near the flash lamp module 110.

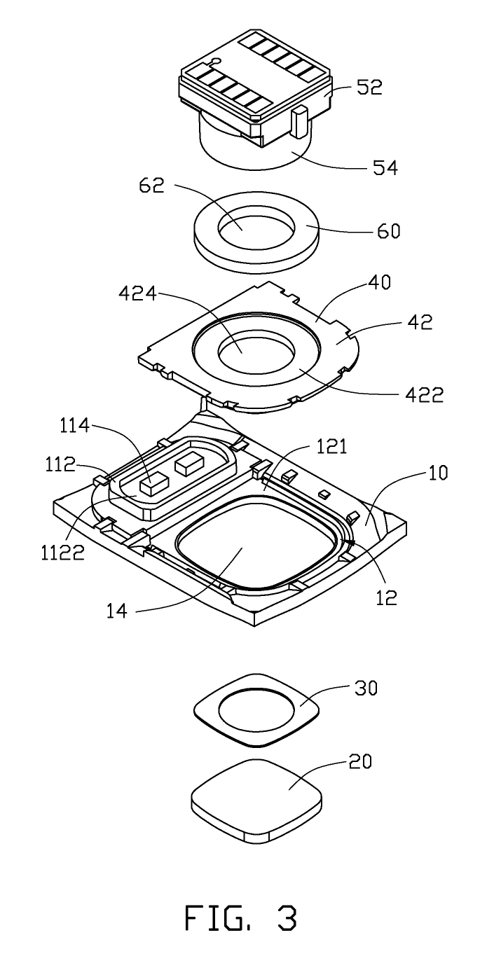

FIG. 3 further shows that the housing 10 has a generally concave cavity 12. A lens aperture 14 is defined through the bottom wall 121 of the concave cavity 12. The housing 10 has a lamp aperture 16 defined therethrough. The lamp aperture 16 is located near the lens aperture 14.

The lens module 100 is received inside the housing 10 and exposed through the lens aperture 14. The lens module 100 includes a protective member 20, an adhesive sheet 30, a base seat 40, an imaging assembly 50, and an annular cushion 60. The protective member 20 is a transparent resin or glass flake.

The flash lamp module 110 includes a receiving seat 112 and two flash lamp members 114. The receiving seat 112 is attached to the inside surface of the housing 10, received in and extends out of the lamp aperture 16. The receiving seat 112 defines a recess 1122. The flash lamp members 114 are attached inside the recess 1122. The flash lamp members 114 can emit lamp light through the non-opaque receiving seat 112 to light a subject.

The adhesive sheet 30 defines a middle round hole 32. The base seat 40 includes a base body 42 and a protruding stage 44. The protruding stage 44 is formed on the base body 42. The base body 42 engages into the concave cavity 12. The base body 42 defines an annular groove 422 for receiving the cushion 60. The protruding stage 44 defines an accommodating cavity 442 for accommodating the protective member 20. A lighting aperture 424 is defined through the bottom wall of the accommodating cavity 442.

The imaging assembly 50 includes a base member 52 and a lens barrel 54 mounted on the base member 52. The lens barrel 54 is secured in the annular groove 422 of the base seat 40. The lens barrel 54 has a light receiving aperture 522, through which the outside light can pass and strike on the photosensitive sensor inside the imaging assembly 50. The annular cushion 60 can be made of rubber, facilitating the securing of the lens barrel 54 into the annular groove 422. The cushion 60 has a through center hole 62.

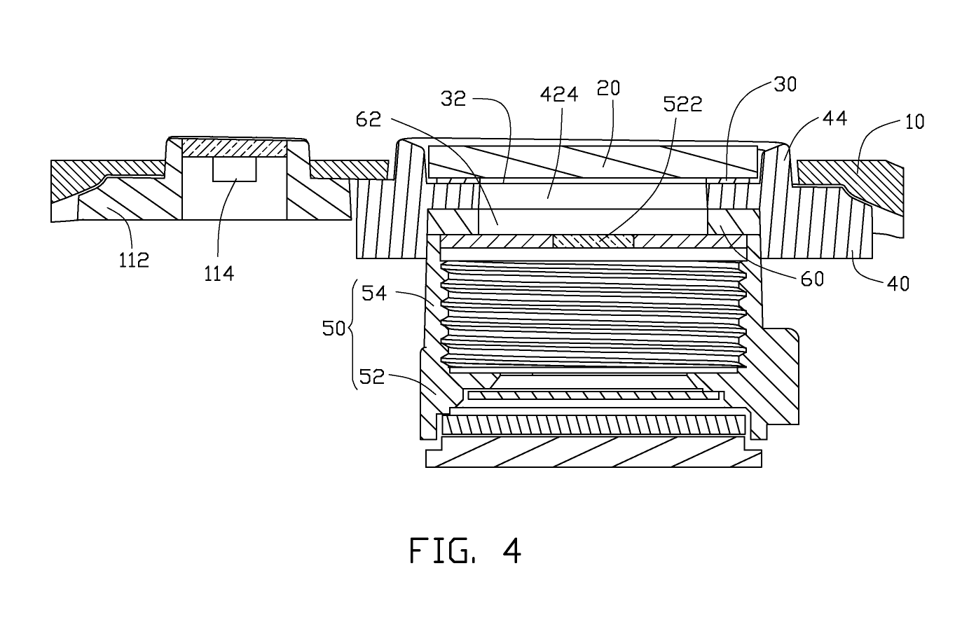

FIG. 4 shows an assembled portable electronic device 100. When assembled, the adhesive sheet 30 adheres the protective member 20 to the bottom of the accommodating cavity 442. The cushion 60 and the lens barrel 54 are secured in the annular groove 422. The cushion 60 is retained between the top wall of the lens barrel 54 and the bottom wall of the annular groove 422. The base seat 40 is fixed to the housing 10. The base member 42 is secured in the concave cavity 12 and the protruding stage 44 engages through the lens aperture 14. The round hole 32, the lighting aperture 424, the center hole 62, the light receiving aperture 522 are coaxially aligned.

In use, the outside light can pass through the transparent protective member 20, the round hole 32, the lighting aperture 424, the center hole 62, and the light receiving aperture 522 to arrive at the photosensitive sensor. Accordingly, the imaging assembly 50 can capture images using incident light. In the case of dark environments, the flash lamp members 114 functions to emit lamp light through the receiving seat 112. Due to blocking of the base seat 40, the lamp light cannot refract into the imaging assembly 50. Accordingly, the imaging of the imaging assembly 50 cannot be influenced by the lamp light from the flash lamp members 114.

It is to be understood, however, that even through numerous characteristics and advantages of exemplary embodiments have been set forth in the foregoing description, together with details of the structure and function of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A portable electronic device, comprising:
a housing defining a lens aperture;
a lens module comprising an imaging assembly and a base seat, the base seat defining a lighting aperture, the imaging assembly accommodated in the housing and aligned with the lens aperture and the lighting aperture, the imaging assembly secured in the base seat, and the base seat secured in and exposed through the lens aperture, the imaging assembly configured for receiving incident light through the lighting aperture and the lens aperture.

2. The portable electronic device as claimed in claim 1, wherein the base seat comprises a base member, the base member defining an annular groove; the imaging assembly comprises a lens barrel secured in the annular groove.

3. The portable electronic device as claimed in claim 2, wherein:
the base member comprises a protruding stage opposite to the annular groove;
the protruding stage defines an accommodating cavity, the annular groove, the accommodating cavity and the lighting aperture communicate with each other; and
the lens module further comprises a protective member, the protective member secured in the accommodating cavity.

4. The portable electronic device as claimed in claim 3, wherein the lens module further comprises an adhesive sheet, the adhesive sheet adhering the protective member within the accommodating cavity.

5. The portable electronic device as claimed in claim 3, wherein:
the housing defines a concave cavity;
the lens aperture is defined through the bottom of the concave cavity;
the base member secured in the concave cavity; and
the protruding stage secured in the lens aperture.

6. The portable electronic device as claimed in claim 2, wherein the lens module further comprise a cushion, the cushion secured in the annular groove and abuts the lens barrel.

7. The portable electronic device as claimed in claim 1, wherein the portable electronic device further comprises a flash lamp module, the flash lamp module assembled to the housing adjacent to the lens module.

8. The portable electronic device as claimed in claim 7, wherein:
the flash lamp module comprises a receiving seat and at least one flash lamp member; and
the receiving seat is secured in the housing, and the at least one flash lamp member is attached below the receiving seat and emitting light through the receiving seat.

9. The portable electronic device as claimed in claim 8, wherein the receiving seat comprise a recess, the at least one flash lamp member received in the recess.

10. A portable electronic device, comprising:
a housing;
a lens module secured in the housing and configured for receiving incident light from the outside of the housing
a flash lamp module secured in the housing adjacent to the lens module, the flash lamp module comprising a flash lamp member emitting light to the outside of the housing, and a recess receiving the flash lamp member and blocking flash light from refracting inside the housing into the lens module.

11. The portable electronic device as claimed in claim 10, wherein:
the housing defines a lens aperture;
the lens module comprises an imaging assembly accommodated in the housing; and
a base seat defining a lighting aperture, the imaging assembly aligned with the lens aperture and the lighting aperture, the imaging assembly secured in the base seat, and the base seat secured in and exposed through the lens aperture.

12. The portable electronic device as claimed in claim 11, wherein the base seat comprises a base member, the base member defining an annular groove; the imaging assembly comprises a lens barrel secured in the annular groove.

13. The portable electronic device as claimed in claim 12, wherein:
the base member comprises a protruding stage opposite to the annular groove, the protruding stage defines an accommodating cavity; the annular groove, the accommodating cavity and the lighting aperture communicate with each other; and
the lens module further comprises a protective member, the protective member secured in the accommodating cavity.

14. The portable electronic device as claimed in claim 13, wherein the lens module further comprises an adhesive sheet, the adhesive sheet adhering the protective member within the accommodating cavity.

15. The portable electronic device as claimed in claim 13, wherein:
the housing defines a concave cavity, the lens aperture is defined through the bottom of the concave cavity; and
the base member is secured in the concave cavity, the protruding stage is secured in the lens aperture.

16. The portable electronic device as claimed in claim 12, wherein the lens module further comprise a cushion, the cushion secured in the annular groove and abuts the lens barrel.

17. The portable electronic device as claimed in claim 11, wherein the portable electronic device further comprises a flash lamp module, the flash lamp module assembled to the housing adjacent to the lens module.

18. The portable electronic device as claimed in claim 10, wherein the flash lamp module comprises a receiving seat, the receiving seat secured in the housing, the flash lamp member attached below the receiving seat and emitting light through the receiving seat.

19. The portable electronic device as claimed in claim 18, wherein the recess is defined in the receiving seat.
